(19) United States
(12) Patent Application Publication
(10) Pub. No.: US 2025/0259269 A1
(43) Pub. Date: Aug. 14, 2025

(54) HIGH DYNAMIC RANGE (HDR) IMAGE GENERATION WITH MULTI-DOMAIN MOTION CORRECTION

(71) Applicant: QUALCOMM Incorporated, San Diego, CA (US)

(72) Inventors: Sanjaya Kumar NAYAK, Balasore (IN); Chanchal RAJ, Bangalore (IN); Pradeep VEERAMALLA, Hyderabad (IN); Ron GAIZMAN, Hof HaCarmel (IL); Shizhong LIU, San Diego, CA (US); Ravi Shankar CHEKURI, Hyderabad (IN); Weiliang LIU, San Diego, CA (US); Sandeep RAMISETTY, Hyderabad (IN); Narayana Karthik RAVIRALA, San Diego, CA (US)

(21) Appl. No.: 18/866,050

(22) PCT Filed: May 23, 2023
(86) PCT No.: PCT/US2023/067365

§ 371 Date: Nov. 14, 2024

(30) Foreign Application Priority Data
Jul. 31, 2022 (IL) 295203

(51) Int. Cl. G06T 5/50; G06T 5/94; H04N 23/63

(52) U.S. Cl. CPC G06T 5/50; G06T 5/94; H04N 23/632; G06T 2207/10144; G06T 2207/20208; G06T 2207/20221

(57) ABSTRACT

Disclosed are systems, apparatuses, processes, and computer-readable media to capture images with subjects at different depths of fields. A method of processing image data includes obtaining a first image captured using an image sensor, the first image being associated with a first exposure: obtaining a second image captured using the image sensor, the second image being associated with a second exposure that is longer than the first exposure: modifying a first region of the first image based on a first transformation and a second region of the first image based on a second transformation to generate a modified first image; and generating a combined image at least in part by combining the modified first image and the second image.

### CROSS-REFERENCE TO RELATED APPLICATIONS

This application for Patent is a 371 of international Patent Application PCT/US2023/067365, filed May 23, 2023, which claims priority to Isreal Patent Application 295203, filed Jul. 31, 2022, all of which are hereby incorporated by referenced in their entirety and for all purposes.

### FIELD

In some examples, systems and techniques are described for generating a high dynamic range (HDR) image using motion correction in different domains.

### BACKGROUND

A camera is a device that receives light and captures image frames, such as still images or video frames, using an image sensor. Cameras may include processors, such as image signal processors (ISPs), that can receive one or more image frames and process the one or more image frames. For example, a raw image frame captured by a camera sensor can be processed by an ISP to generate a final image. Cameras can be configured with a variety of image capture and image processing settings to alter the appearance of an image. Some camera settings are determined and applied before or during capture of the photograph, such as ISO, exposure time, aperture size, f/stop, shutter speed, focus, and gain. Other camera settings can configure post-processing of a photograph, such as alterations to contrast, brightness, saturation, sharpness, levels, curves, or colors.

Cameras can be configured with a variety of image capture and image processing settings. Application of different settings can result in frames or images with different appearances. Some camera settings are determined and applied before or during capture of the photograph, such as ISO, exposure time (also referred to as exposure duration), aperture size, f/stop, shutter speed, focus, and gain. Other camera settings can configure post-processing of a photograph, such as alterations to contrast, brightness, saturation, sharpness, levels, curves, or colors.

### SUMMARY

In some examples, systems and techniques are described for generating a high dynamic range (HDR) image with multi-domain motion correction. The systems and techniques can improve image quality of HDR images, such as by reducing noise or other deficiencies (e.g., reducing ghosting) resulting from motion in the HDR images.

In some examples, systems and techniques are described for HDR image generation with multi-domain motion correction. Disclosed are systems, apparatuses, methods, and computer-readable media for processing one or more images. According to at least one example, a method is provided for processing one or more images. The method includes: obtaining a first image captured using an image sensor, the first image being associated with a first exposure; obtaining a second image captured using the image sensor, the second image being associated with a second exposure that is longer than the first exposure; modifying a first region of the first image based on a first transformation and a second region of the first image based on a second transformation to generate a modified first image; and generating a combined image at least in part by combining the modified first image and the second image.

In another example, an apparatus for processing one or more images is provided that includes at least one memory and at least one processor coupled to the at least one memory. The at least one processor is configured to: obtain a first image captured using an image sensor, the first image being associated with a first exposure; obtain a second image captured using the image sensor, the second image being associated with a second exposure that is longer than the first exposure; modify a first region of the first image based on a first transformation and a second region of the first image based on a second transformation to generate a modified first image; and generate a combined image at least in part by combining the modified first image and the second image.

In another example, a non-transitory computer-readable medium is provided that has stored thereon instructions that, when executed by one or more processors, cause the one or more processors to: obtain a first image captured using an image sensor, the first image being associated with a first exposure; obtain a second image captured using the image sensor, the second image being associated with a second exposure that is longer than the first exposure; modify a first region of the first image based on a first transformation and a second region of the first image based on a second transformation to generate a modified first image; and generate a combined image at least in part by combining the modified first image and the second image.

In another example, an apparatus for processing one or more images is provided. The apparatus includes: means for obtaining a first image captured using an image sensor, the first image being associated with a first exposure; means for obtaining a second image captured using the image sensor, the second image being associated with a second exposure that is longer than the first exposure; means for modifying a first region of the first image based on a first transformation and a second region of the first image based on a second transformation to generate a modified first image; and means for generating a combined image at least in part by combining the modified first image and the second image.

In some aspects, the image sensor is oriented in a same direction as a display for displaying preview images captured by the image sensor.

In some aspects, the first region is associated with an object at a first depth in a scene relative to the image sensor, and the second region includes a background region at a second depth in the scene relative to the image sensor.

In some aspects, one or more of the methods, apparatuses, and computer-readable medium described above further comprise: generating a first matrix for performing the first transformation; and generating a second matrix for performing the second transformation.

In some aspects, the second matrix is generated based on movement detected by a motion sensor between a first time when the first image is captured and a second time when the second image is captured.

In some aspects, the motion sensor comprises a gyroscope sensor, and wherein the second transformation comprises a rotational transformation.

In some aspects, one or more of the methods, apparatuses, and computer-readable medium described above further comprise: extracting first feature points from the first image; and extracting second feature points from the second image.

In some aspects, one or more of the methods, apparatuses, and computer-readable medium described above further comprise: increasing a brightness of the first image based on an exposure ratio difference between the first image and the second image.

In some aspects, one or more of the methods, apparatuses, and computer-readable medium described above further comprise: detecting an object in the second image; and determining a bounding region associated with a location of the object in the second image.

In some aspects, one or more of the methods, apparatuses, and computer-readable medium described above further comprise: identifying a subset of the first feature points within the bounding region; identifying a subset of the second feature points within the bounding region; and generating the first matrix based on the subset of the first feature points and the subset of the second feature points.

In some aspects, based on the first matrix and the second matrix, a hybrid transformation matrix for modifying the first region of the first image and the second region of the first image.

In some aspects, one or more of the methods, apparatuses, and computer-readable medium described above further comprise: adding values from the first matrix to the hybrid transformation matrix that at least correspond to the first region; and adding values from the second matrix to the hybrid transformation matrix that at least correspond to the second region.

In some aspects, one or more of the methods, apparatuses, and computer-readable medium described above further comprise: determining a transition region between the first region and the second region based on a size of a bounding region associated with a location of an object in at least one of the first image or the second image; determining values associated with the transition region based on a representation of the first matrix and the second matrix; and adding the values associated with the transition region to the hybrid transformation matrix.

In some aspects, the representation of the first matrix and the second matrix includes a weighted average of the first matrix and the second matrix.

In some aspects, the representation of the first matrix and the second matrix is based on a proportional distance from an inner edge of the transition region to an outer edge of the transition region.

In some aspects, the first transformation comprises a translational matrix associated with movement of the image sensor during the obtaining of the first image and the obtaining of the second image.

In some aspects, the combined image is an HDR image.

In some aspects, the apparatus is, is part of, and/or includes a wearable device, an extended reality (XR) device (e.g., a virtual reality (VR) device, an augmented reality (AR) device, or a mixed reality (MR) device), a head-mounted device (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A, FIG. 1B, and FIG. 1C are diagrams illustrating example configurations for an image sensor of an image capture device, in accordance with aspects of the present disclosure.

FIG. 2 is a block diagram illustrating an architecture of an image capture and processing device, in accordance with aspects of the present disclosure.

FIG. 3 is a block diagram illustrating an example of an image capture system, in accordance with aspects of the present disclosure.

FIG. 4 is a diagram illustrating generation of a fused frame from short and long exposure frames, in accordance with aspects of the present disclosure.

FIG. 5 is a diagram illustrating long exposure and short exposure streams from an image sensor, in accordance with certain of the present disclosure.

FIG. 6 is a diagram illustrating an example of in-line fusion of one or more short exposure frames and one or more long exposure frames, in accordance with aspects of the present disclosure.

FIG. 7A is a diagram illustrating a long exposure image and a short exposure image that are captured by an image capturing system that experiences displacement in multiple domains accordance with some aspects.

FIG. 7B illustrates illustrating the long exposure image and the short exposure image in FIG. 7A after rotational correction in accordance with some aspects of the disclosure.

FIG. 8 is an example high dynamic range (HDR) image generated by an HDR fusion system after correcting for rotational movement in accordance with some aspects of the disclosure.

FIG. 9 illustrates a diagram illustrating an example image processing system for synthesizing an HDR image using a multi-domain motion correction in accordance with some aspects of the disclosure.

FIGS. 10A-10D are conceptual diagrams illustrating various matrixes generated by an HDR fusion system to correct spatial and rotational alignment in accordance with some aspects of the disclosure.

FIG. 11 is a flowchart illustrating an example of a method for aligning an image using rotation information using a gyroscope sensor, in accordance with certain of the present disclosure.

FIG. 12 is a conceptual diagram of key point detection to identify the displacement of an image capturing system in accordance with certain of the present disclosure.

FIG. 13 is a flowchart illustrating an example method for synthesizing an HDR image with multi-domain motion correction, in accordance with aspects of the present disclosure.

FIG. 14 is an illustrative example of a deep learning neural network that can be used to implement the machine learning-based alignment prediction, in accordance with aspects of the present disclosure.

FIG. 15 is an illustrative example of a convolutional neural network (CNN), in accordance with aspects of the present disclosure.

FIG. 16 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The ensuing description provides example aspects only, and is not intended to limit the scope, applicability, or configuration of the disclosure. Rather, the ensuing description of the exemplary aspects will provide those skilled in the art with an enabling description for implementing an aspect of the disclosure. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

The dynamic range of a digital imaging device, such as a digital camera, is the ratio between the largest amount of light that the device can capture without light saturation, and the lowest amount of light the device can accurately measure and distinguish from intrinsic image noise (electrical noise, thermal noise, etc.). Traditionally, digital cameras are able to capture only a small portion of the natural illumination range of a real-world scene. For example, the dynamic range of a scene may be, 100,000:1, while the dynamic range of the image sensor of a digital camera may be, 100:1. When the dynamic range of the scene exceeds the dynamic range of the sensor, details in the regions of highest light levels and/or lowest light levels are lost.

An imaging device can generate a high dynamic range (HDR) image by merging multiple images that captured with different exposure settings. For instance, an imaging device can generate an HDR image by merging together a short-exposure image captured with a short exposure time, a medium-exposure image captured with a medium exposure time that is longer than the short exposure time, and a long-exposure image captured with a long exposure time that is longer than the medium exposure time. Because short-exposure images are generally dark, they generally preserve the most detail in the highlights (bright areas) of a photographed scene. Medium-exposure images and the long-exposure images are generally brighter than short-exposure images, and may be overexposed (e.g., too bright to make out details) in the highlight portions (bright areas) of the scene. Because long-exposure images generally include bright portions, they may preserve detail in the shadows (dark areas) of a photographed scene. Medium-exposure images and the short-exposure images are generally darker than long-exposure images, and may be underexposed (e.g., too dark to make out details in) in the shadow portions (dark areas) of the scene, making their depictions of the shadows too dark to observe details. To generate an HDR image, the imaging device may, for example, use portions of the short-exposure image to depict highlights (bright areas) of the photographed scene, use portions of the long-exposure image depicting shadows (dark areas) of the scene, and use portions of the medium-exposure image depicting other areas (other than highlights and shadows) of a scene.

In some cases, an image capturing system (e.g., a mobile device) can include a camera for capturing forward-facing images with respect to a display to allow the user to capture self-portraits and participate in video calls. For example, in a self-portrait, the user is capturing an image of a foreground (the user's face) and an object in a background (e.g., a landmark). To capture an image, the user holds the image capturing system away from their body while previewing the image and inputs a command such as depressing a physical button or a virtual button on the display of the image capturing system. To capture a high-quality HDR image with low noise, the user cannot move the image capturing system because the image capturing system is capturing multiple images (e.g., a long-exposure image and a short-exposure image) at different times. The user extends the image capturing system away from their body (e.g., the user's face) and frames an object of interest in the background. While the user has extended the image capturing system away from their body, the user will experience normal tremors that displace the image capturing system and can create noise and other artifacts within the HDR image. In addition, the user inputs a command by depressing a button or providing a screen input that applies a force to the image capturing system, and the image capturing system may move based on that input. For example, an image capturing system can include a physical button on a side, and when a hand of the user is holding the image capturing system also clicks on the physical button, the input can inadvertently result in rotational movement of the image capturing system while capturing the HDR image. Some displacement (e.g., movement in the Cartesian coordinates) of the image capturing system can also occur from intrinsic effects (e.g., tremors) or extrinsic effects (e.g., wind). The rotation and displacement can also be further affected by longer exposure times because a forward-facing lens of the camera is smaller and inherently limits an amount of light, which increases the necessary exposure time for the short exposure image and the long exposure image and increases the likelihood of some aberrational movement due to intrinsic or extrinsic motion.

The long exposure image and the short exposure image can be misaligned based on rotational movement of the image capturing system and displacement of the image capturing system. The rotation can be recorded by a gyroscope sensor and the long exposure image and short exposure image can be compensated based on detected motion over time. An HDR image created from rotational correction of the long exposure image and short exposure image will align objects at far depths (e.g., distance from the image capturing system) well but objects that are close (e.g., the user's face) may be misaligned. An HDR image can also be corrected based on detecting key points within an image. One example method of detecting a key point is detecting an edge on the image or other strong features of an image, such as a corner of an object. HDR image correction by detecting key points is beneficial for stronger features that are present at closer depths (e.g., closer to the camera), but there is potential misalignment of close objects (e.g., the user's face) and objects at far depth (e.g., a landmark object in the background).

In some aspects, systems, apparatuses, processes (also referred to as methods), and computer-readable media (collectively referred to herein as “systems and techniques”) are described for generating an HDR image using a combination of rotational and translational correction. For instance, an imaging system can identify a foreground object such as a face of the user in a self-portrait. The imaging system can use the foreground object to determine a displacement of the imaging system, such as a translational matrix that identifies movement. In one illustrative example, the imaging system can identify key points associated with the foreground object and identify displacement between the short-exposure image and the long-exposure image. The imaging system can use a sensor such as a gyroscope sensor to identify rotation associated with the imaging system.

Based on the displacement and the rotation of the imaging system, the imaging system can perform a rotational correction on the background object and perform a spatial correction on the foreground object. In one illustrative aspect, the imaging system is configured to determine a border region between the foreground object and other objects (e.g., the background object) and correct the border region based on an interpolation of the rotation correction and the spatial correction.

Additional details and aspects of the present disclosure are described in more detail below with respect to the figures.

Image sensors include one or more arrays of photodiodes or other photosensitive elements. Each photodiode measures an amount of light that eventually corresponds to a particular pixel in the image produced by the image sensor. In some cases, different photodiodes may be covered by different color filters of a color filter array and may thus measure light matching the color of the color filter covering the photodiode.

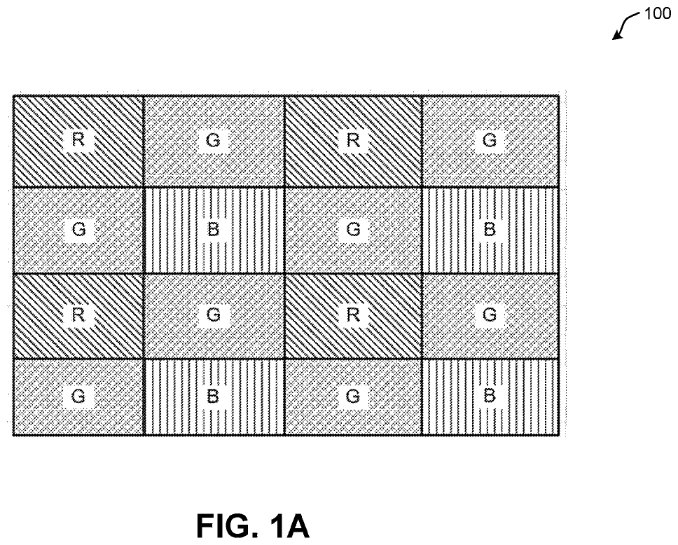

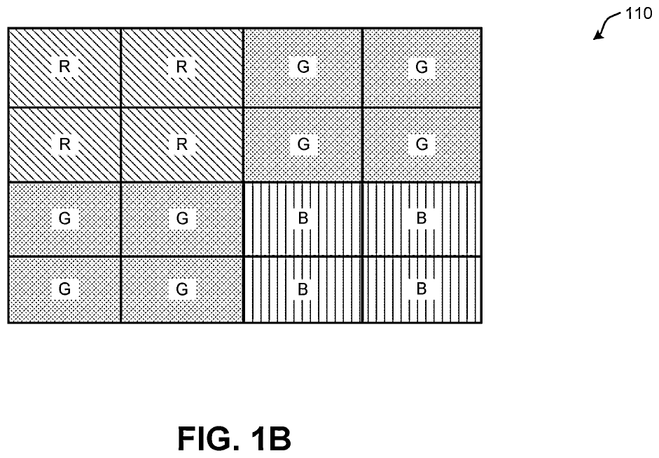

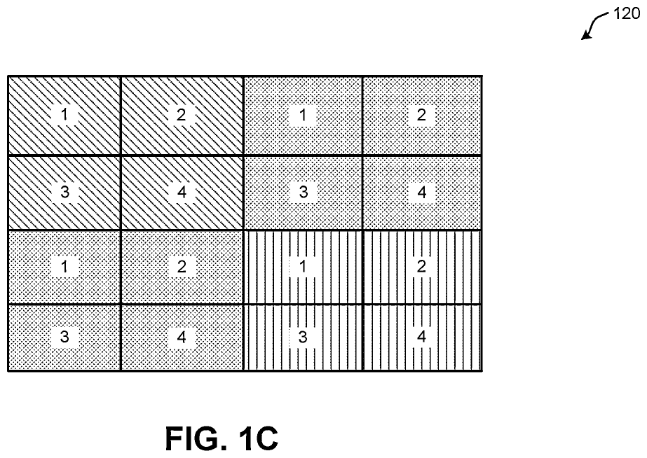

Various color filter arrays can be used, including a Bayer color filter array, a quad color filter array (also referred to as a quad Bayer filter or QCFA), and/or other color filter array. An example of a Bayer color filter array 100 is shown in FIG. 1A. As shown, the Bayer color filter array 100 includes a repeating pattern of red color filters, blue color filters, and green color filters. As shown in FIG. 1B, a QCFA 110 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the QCFA 110 shown in FIG. 1B is repeated for the entire array of photodiodes of a given image sensor. Using either QCFA 110 or the Bayer color filter array 100, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. The different photodiodes throughout the pixel array can have different spectral sensitivity curves, therefore responding to different wavelengths of light. Monochrome image sensors may also lack color filters and therefore lack color depth.

In some cases, subgroups of multiple adjacent photodiodes (e.g., 2×2 patches of photodiodes when QCFA 110 shown in FIG. 1B is used) can measure the same color of light for approximately the same region of a scene. For example, when photodiodes included in each of the subgroups of photodiodes are in close physical proximity, the light incident on each photodiode of a subgroup can originate from approximately the same location in a scene (e.g., a portion of a leaf on a tree, a small section of sky, etc.).

In some examples, a brightness range of light from a scene may significantly exceed the brightness levels that the image sensor can capture. For example, a digital single-lens reflex (DSLR) camera may be able to capture a 1:30,000 contrast ratio of light from a scene while the brightness levels of an HDR scene can exceed a 1:1,000,000 contrast ratio.

In some cases, HDR sensors may be utilized to enhance the contrast ratio of an image captured by an image capture device. In some examples, HDR sensors may be used to obtain multiple exposures within one image or frame, where such multiple exposures can include short (e.g., 5 ms) and long (e.g., 15 or more ms) exposure times. As used herein, a long exposure time generally refers to any exposure time that longer than a short exposure time.

In some implementations, HDR sensors may be able to configure individual photodiodes within subgroups of photodiodes (e.g., the four individual R photodiodes, the four individual B photodiodes, and the four individual G photodiodes from each of the two 2×2 G patches in the QCFA 110 shown in FIG. 1B) to have different exposure settings. A collection of photodiodes with matching exposure settings is also referred to as photodiode exposure group herein. FIG. 1C illustrates a portion of an image sensor array with a QCFA filter that is configured with four different photodiode exposure groups 1 through 4. As shown in the example photodiode exposure group array 120 in FIG. 1C, each 2×2 patch can include a photodiode from each of the different photodiode exposure groups for a particular image sensor. Although four groupings are shown in a specific grouping in FIG. 1C, a person of ordinary skill will recognize that different numbers of photodiode exposure groups, different arrangements of photodiode exposure groups within subgroups, and any combination thereof can be used without departing from the scope of the present disclosure.

As noted with respect to FIG. 1C, in some HDR image sensor implementations, exposure settings corresponding to different photodiode exposure groups can include different exposure times (also referred to as exposure lengths), such as short exposure, medium exposure, and long exposure. In some cases, different images of a scene associated with different exposure settings can be formed from the light captured by the photodiodes of each photodiode exposure group. For example, a first image can be formed from the light captured by photodiodes of photodiode exposure group 1, a second image can be formed from the photodiodes of photodiode exposure group 2, a third image can be formed from the light captured by photodiodes of photodiode exposure group 3, and a fourth image can be formed from the light captured by photodiodes of photodiode exposure group 4. Based on the differences in the exposure settings corresponding to each group, the brightness of objects in the scene captured by the image sensor can differ in each image. For example, well-illuminated objects captured by a photodiode with a long exposure setting may appear saturated (e.g., completely white). In some cases, an image processor can select between pixels of the images corresponding to different exposure settings to form a combined image.

In one illustrative example, the first image corresponds to a short exposure time (also referred to as a short exposure image), the second image corresponds to a medium exposure time (also referred to as a medium exposure image), and the third and fourth images correspond to a long exposure time (also referred to as long exposure images). In such an example, pixels of the combined image corresponding to portions of a scene that have low illumination (e.g., portions of a scene that are in a shadow) can be selected from a long exposure image (e.g., the third image or the fourth image). Similarly, pixels of the combined image corresponding to portions of a scene that have high illumination (e.g., portions of a scene that are in direct sunlight) can be selected from a short exposure image (e.g., the first image.

In some cases, an image sensor can also utilize photodiode exposure groups to capture objects in motion without blur. The length of the exposure time of a photodiode group can correspond to the distance that an object in a scene moves during the exposure time. If light from an object in motion is captured by photodiodes corresponding to multiple image pixels during the exposure time, the object in motion can appear to blur across the multiple image pixels (also referred to as motion blur). In some implementations, motion blur can be reduced by configuring one or more photodiode groups with short exposure times. In some implementations, an image capture device (e.g., a camera) can determine local amounts of motion (e.g., motion gradients) within a scene by comparing the locations of objects between two consecutively captured images. For example, motion can be detected in preview images captured by the image capture device to provide a preview function to a user on a display. In some cases, a machine learning model can be trained to detect localized motion between consecutive images.

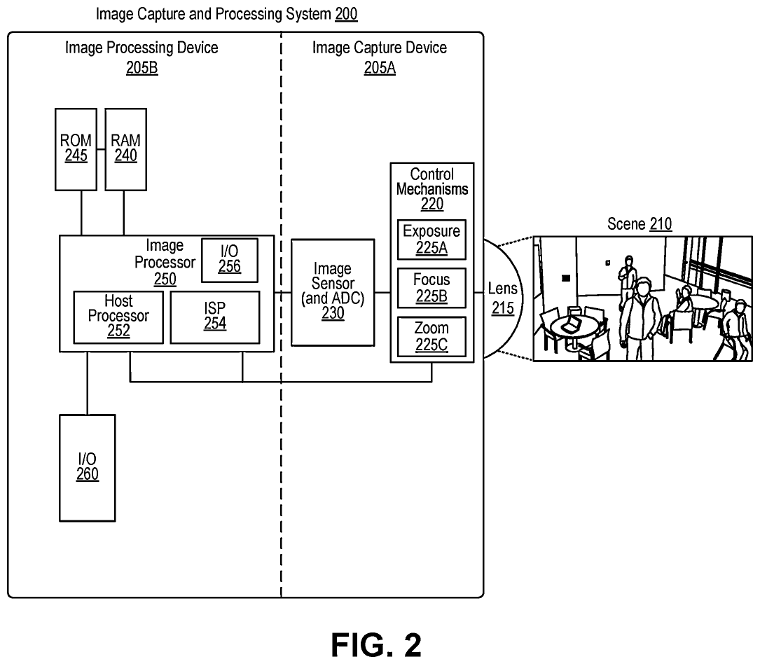

Various aspects of the techniques described herein will be discussed below with respect to the figures. FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array (as shown in FIG. 1A), a QCFA (see FIG. 1B), and/or any other color filter array.

Returning to FIG. 1A and FIG. 1B, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

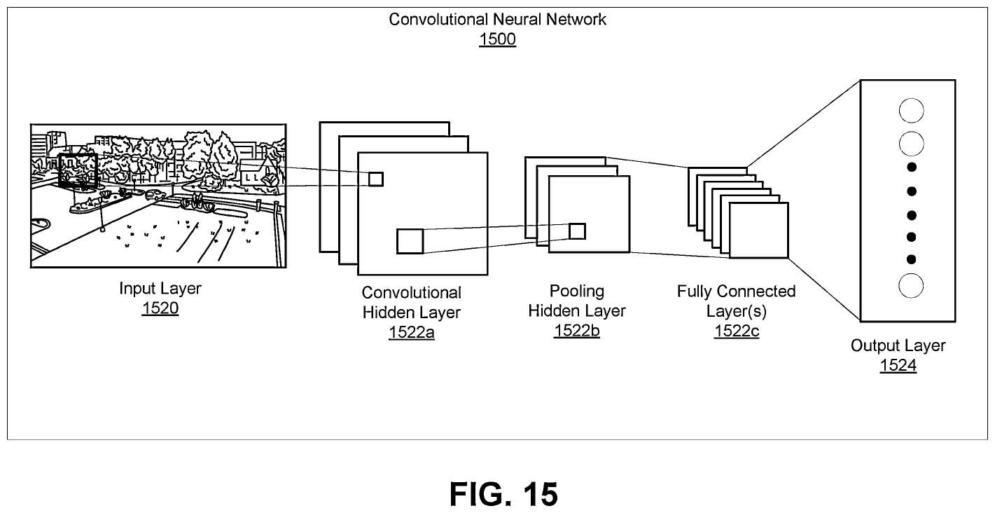

The image processor 250 may include one or more processors, such as one or more ISPs (e.g., ISP 254), one or more host processors (e.g., host processor 252), and/or one or more of any other type of processor 1610 discussed with respect to the computing system 1600 of FIG. 15. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output devices 1635, any other input devices 1645, or some combination thereof. In some cases, a caption may be input into the image processing device 205B through a physical keyboard or keypad of the I/O devices 260, or through a virtual keyboard or keypad of a touchscreen of the I/O devices 260. The I/O 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

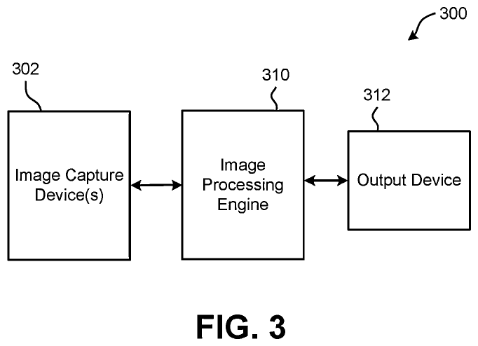

FIG. 3 is a block diagram illustrating an example of an image capture system 300. The image capture system 300 includes various components that are used to process input images or frames to produce an output image or frame. As shown, the components of the image capture system 300 include one or more image capture devices 302, an image processing engine 310, and an output device 312. The image processing engine 310 can produce high dynamic range depictions of a scene, as described in more detail herein.

The image capture system 300 can include or be part of an electronic device or system. For example, the image capture system 300 can include or be part of an electronic device or system, such as a mobile or stationary telephone handset (e.g., smartphone, cellular telephone, or the like), an extended reality (XR) device (e.g., a virtual reality (VR) device, an augmented reality (AR) device, or a mixed reality (MR) device), a vehicle or computing device/system of a vehicle, a server computer (e.g., in communication with another device or system, such as a mobile device, an XR system/device, a vehicle computing system/device, etc.), a desktop computer, a laptop or notebook computer, a tablet computer, a set-top box, a television, a camera device, a display device, a digital media player, a video streaming device, or any other suitable electronic device. In some examples, the image capture system 300 can include one or more wireless transceivers (or separate wireless receivers and transmitters) for wireless communications, such as cellular network communications, 802.11 Wi-Fi communications, WLAN communications, Bluetooth or other short-range communications, any combination thereof, and/or other communications. In some implementations, the components of the image capture system 300 can be part of the same computing device. In some implementations, the components of the image capture system 300 can be part of two or more separate computing devices.

While the image capture system 300 is shown to include certain components, one of ordinary skill will appreciate that image capture system 300 can include more components or fewer components than those shown in FIG. 3. In some cases, additional components of the image capture system 300 can include software, hardware, or one or more combinations of software and hardware. For example, in some cases, the image capture system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the image capture system 300 can include and/or can be implemented using electronic circuits or other electronic hardware, which can include one or more programmable electronic circuits (e.g., DSPs, microprocessors, microcontrollers, GPUs, CPUs, any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture system 300.

The one or more image capture devices 302 can capture image data and generate images (or frames) based on the image data and/or can provide the image data to the image processing engine 310 for further processing. The one or more image capture devices 302 can also provide the image data to the output device 312 for output (e.g., on a display). In some cases, the output device 312 can also include storage. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In addition to image data, the image capture devices can also generate supplemental information such as the amount of time between successively captured images, timestamps of image capture, or the like.

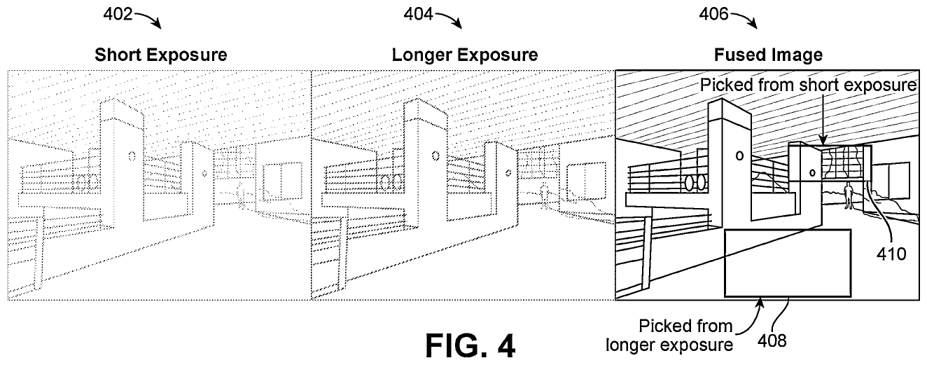

FIG. 4 illustrates techniques for generating a fused frame from short and long exposure frames. As shown, a short exposure frame 402 and a long exposure frame 404 may be taken, which may be fused to provide a fused frame output 406 (e.g., an HDR frame output). Due to a bit depth of an image capture sensor, some pixels of a capture frame may be oversaturated, resulting in the image not showing some textures of a scene as shown in the short exposure frame 402. Thus, to generate an HDR frame, both short and long exposure frames may be captured, which may be fused (e.g., combined) to generate an HDR output frame. A fusion of short and long exposure frames may be performed to generate a fused output frame that includes parts of the short exposure frame and parts of the long exposure frame. For example, region 408 of the fused frame output 406 may be from the long exposure frame 404, while region 410 of the fused frame output 406 may be from the short exposure frame 402. However, fusing short and long exposure frames may result in irregularities due to global motion (e.g., motion of the image capture device). For example, from the time when the long exposure frame is captured to the time when the short-exposure frame is captured, the image capture device or objects in a scene may have moved, causing irregularities if steps are not taken to align the short and long exposure frames prior to fusing the frames together. This global motion issue may also arise due to a rolling shutter, as described in more detail herein.

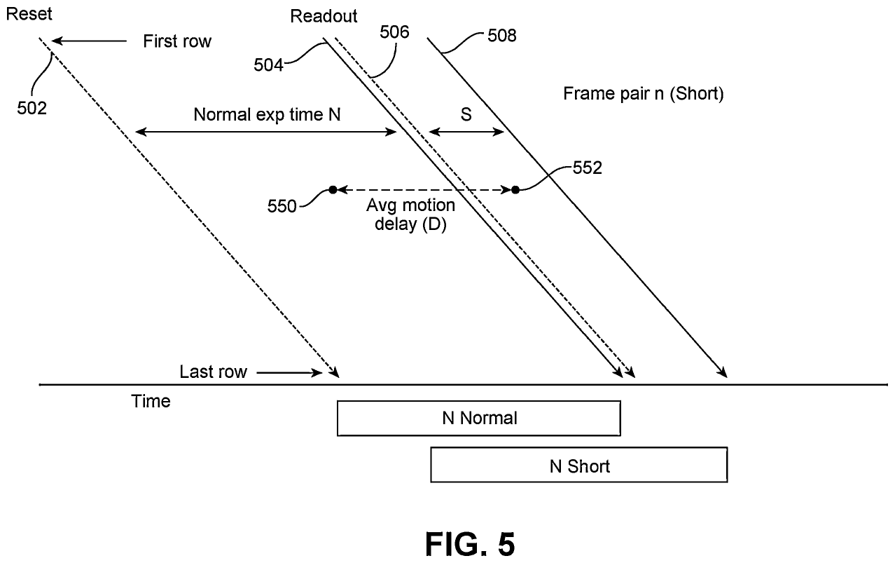

FIG. 5 is a diagram illustrating long exposure and short exposure streams (e.g., MIPI stream) from an image sensor (e.g., image sensor 230) to an imaging front end for processing. Line 502 represents the start of long exposure sensing (also referred to herein as normal exposure sensing), and line 504 represents the end of the long exposure sensing. The long exposure sensing starts from the first row of a sensor (e.g., image sensor 230 of FIG. 2) to the last row of the sensor, as shown. For each row (e.g., row of photodiodes), once the long exposure sensing has completed, short exposure sensing begins while the long exposure sensing continues to the next row. For example, line 506 represents the beginning of the short exposure sensing, and line 508 represents the end of the short exposure sensing, starting from the first row to the last row of the image sensor. The long exposure sensing (e.g., having a duration labeled “N Normal” in FIG. 5) may begin prior to the short exposure sensing (e.g., having a duration labeled “N short” in FIG. 5).

Once the long exposure sensing for a particular row is completed, a short delay (e.g., associated with the gap between lines 504, 506) occurs before the short exposure sensing begins. Once the short exposure sensing has finished for a particular row, the information for the row is read out from the image sensor for processing. Due to the gap from the long exposure sensing to the short exposure sensing (e.g., shown as an average motion delay (D) in FIG. 5), an opportunity exists for a user who is holding the camera to move and/or for objects in a scene being captured to move, resulting in a misalignment of features in the short and long exposure frames (e.g., features that are common or the same in the short and long exposure frames). For example, a motion delay (D) may exist from time 550 (e.g., time when half of the long exposure data is captured) and time 552 (e.g., the time when half of the short exposure data is captured). The motion delay (D) may be estimated as being the average motion delay associated with different long and short frame capture events (e.g., different HDR frame captures).

Because the sensing occurs one row at a time (e.g., starting from the first row to the last row), a rolling shutter global motion also occurs. The camera or objects in scene may move from when the data for a first row of sensors are captured to when the data for a last row of sensors are captured.

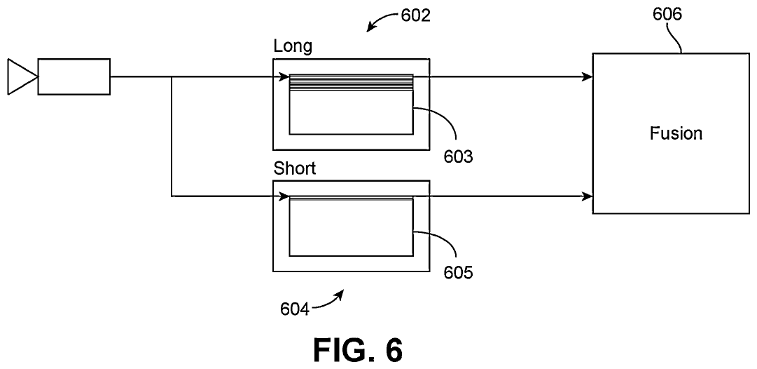

FIG. 6 is a diagram illustrating techniques for an in-line fusion of one or more short exposure frames 604 and one or more long exposure frames 602. A fusion engine 606 can fuse the one or more short exposure frames 604 and the one or more long exposure frames 602 to generate an HDR frame. As described with respect to FIG. 5, long exposure data corresponding to the one or more long exposure frames 602 may be captured for each row prior to the short exposure data corresponding to the one or more short exposure frames 604. Therefore, the data from each row for the one or more long exposure frames 602 may be received and stored in a buffer 603 prior to the data for each row for the one or more short exposure frames 604 being stored in a buffer 605. As shown, the accumulation of data for the one or more long exposure frames 602 may be ahead of the accumulation of data for the one or more short exposure frames 604 (e.g., since the long exposure capture occurs prior to the short exposure capture as shown in FIG. 5).

In some cases, fusion by the fusion engine 606 may begin once a particular number of sensor rows or lines (e.g., the first 3 rows/lines, the first 4 rows/lines, the first 8 rows/lines, or other number of rows/lines) of the short frame data corresponding to the one or more short exposure frames 604 are accumulated. For example, upon receiving the short frame data for the particular number of sensor rows, operation for frame alignment may begin (e.g., instead of waiting for the entire frame to be received). However, various constraints may exist when performing frame alignment. For example, it may not be possible to fully warp a long exposure frame (from one or more long exposure frames 602) to align with a short exposure frame (from the one or more short exposure frames 604). Moreover, due to hardware timing constraints, the programming of alignment may have to be performed two or three frames in advance. In some aspects, a large buffer may be established for capturing frame data. Image data from the image sensor may be written at the center part of the image buffer, enabling the application of shifts in x and y dimensions to the data stored in the buffer for alignment. Moreover, certain aspects of the present disclosure provide techniques for alignment prediction to allow for the programming of alignment operations in advance.

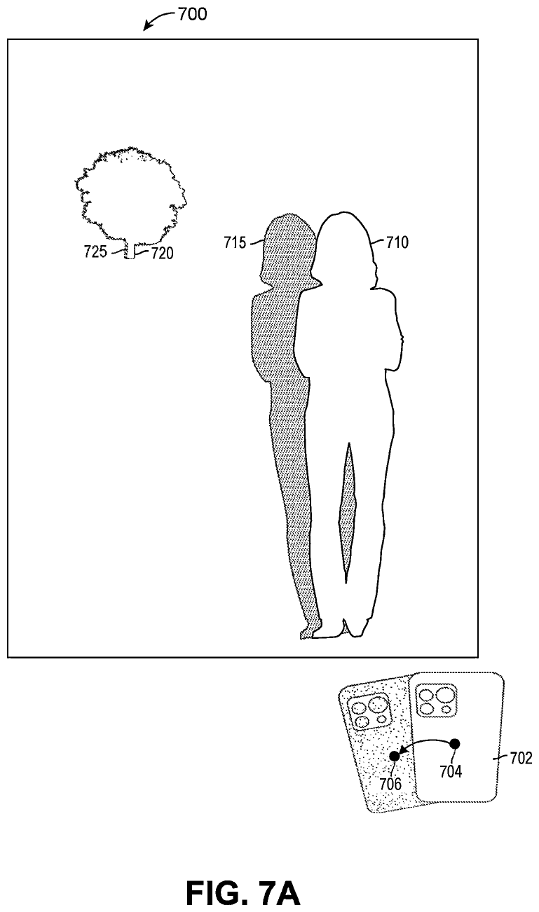

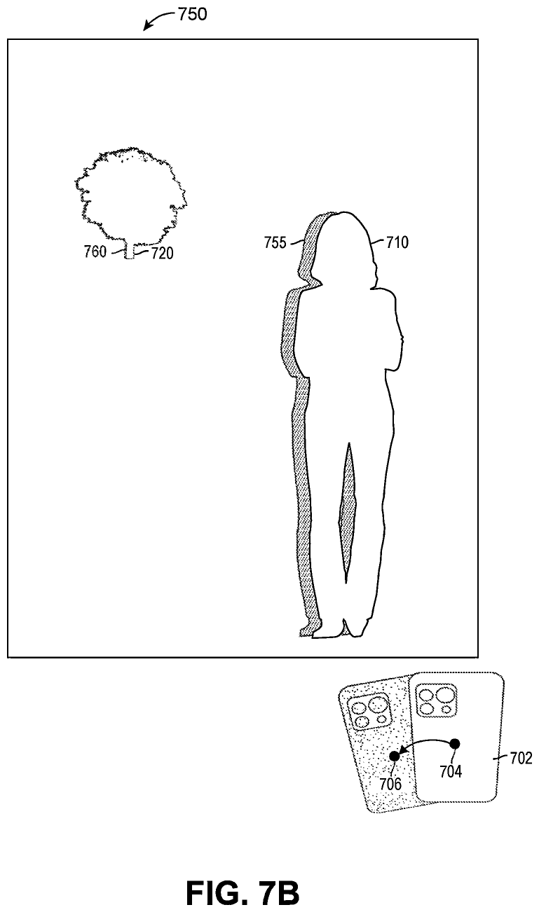

FIG. 7A is a diagram 700 illustrating a long exposure image and a short exposure image that are captured by an image capturing system 702 that experiences displacement in multiple domains accordance with some aspects. In one aspect, a person may hold an image capturing system 702 to capture a self-portrait including a background object, such as the tree. In this illustrative example, the self-portrait has two objects of interest: the user's face and the background. When the user depresses a button on the image capturing system, the image capturing system begins capturing a first image (e.g., a short exposure image) and the image capturing system may move (e.g., due to tremors that are exacerbated based on the user's extending the image capturing system as far away as possible) and finish capturing the short exposure image while the mobile is located at position 704, which is illustrated as a center point of the image capturing system for clarity. After the short exposure image is captured, the image capturing system may begin capturing the long exposure image while the image capturing system may continue moving due to intrinsic or extrinsic factors. At position 706, the image capturing system may finish capturing the long exposure image, and the image capturing system has moved in a plurality of directions. In particular, the image capturing system has shifted in at least one direction (e.g., to the right with respect to the user) and rotated on at least one axis (e.g., yaw, pitch, or roll).

In one illustrative example, a region 710 depicts a foreground object (e.g., a person) in a short exposure image and a region 715 depicts the foreground object in the long exposure image. A region 720 illustrates a background object (e.g., a tree, a landmark, etc.) in the short-exposure image and a region 725 illustrates the background object in the long exposure image. As depicted in FIG. 7A, the region 710 is different than the region 715 because the movement of the image capturing system 702 affects alignment error based on distance from the camera. For example, the region 715 is offset due to displacement of the image capturing system 702 and rotated along due to rotation of the image capturing system 702. In this example, the

The diagram 700 also includes a region 720 that depicts a background object (e.g., a tree) in the short exposure image and a region 725 in the long exposure image. Because the background object has a different depth (e.g., is farther away from the camera), the background object has fewer errors than the foreground object. In some aspects, the approximate error is based on the focal length multiplied by a movement (e.g., rotation, displacement) divided by object distance. For example, the alignment error is inversely proportional from the distance of the camera to the object, with objects closer to the camera exhibiting larger alignment error and objects farther away exhibiting lesser alignment error.

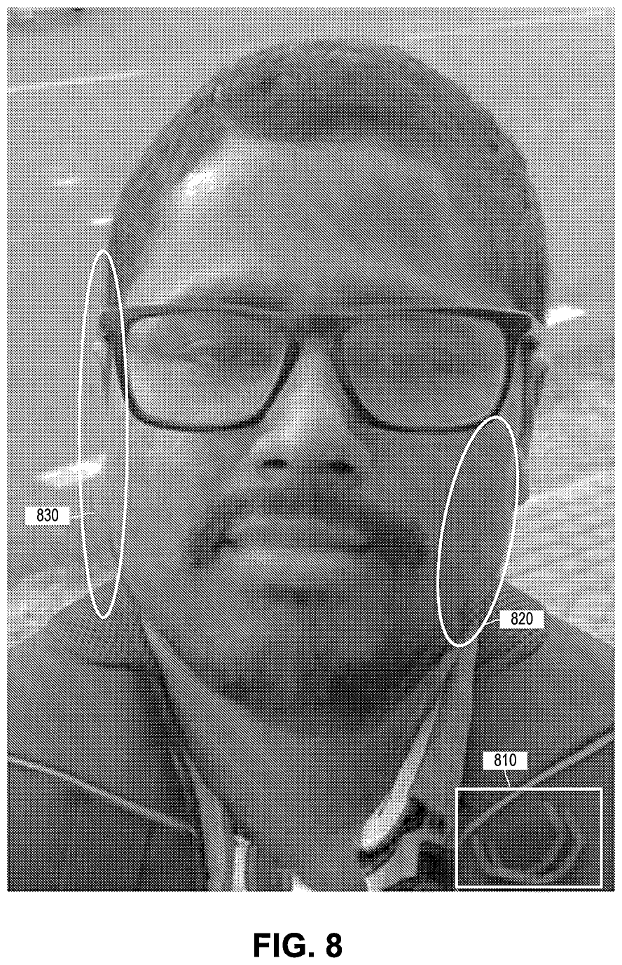

FIG. 7B is a diagram 750 illustrating a long exposure image and a short exposure image in FIG. 7A after rotational correction in accordance with some aspects of the disclosure. The image capturing system 702 may be configured to record movement data from a gyroscope sensor and determine an amount of rotation that occurs between the capturing of the short exposure image and the long exposure image. Based on the captured information, the image capturing system 702 is configured to modify the short exposure image and/or the long exposure image (e.g., a last captured short exposure image and/or a last captured long exposure image). As shown in FIG. 7B, a region 755 corresponding to the person in the long exposure image is corrected based on rotational information from the gyroscope sensor. While the rotational deformation is addressed, the region 755 corresponding to the person (and region 760 corresponding to the background object) in the long exposure image is corrected for one direction of displacement of the image capturing system 702 but alignment errors in another direction of displacement of the image capturing system 702 are still present and cannot be corrected. As illustrated in FIG. 8 below, the alignment errors create noise and ghosting issues that reduce the quality of the HDR image.

FIG. 8 is an example of an HDR image (also referred to as an HDR frame) generated by an HDR fusion system after correcting for rotational movement in accordance with some aspects. As illustrated in FIG. 8, an image is captured by a forward-facing camera in an image capturing system that illustrates a foreground region and a background region. In one illustrative aspect, the region 810 illustrates a buckle that is reproduced twice with a slight offset based on the displacement of the imaging system. The image also includes a noisy region 820 having discontinuities (e.g., noise) based on failure to align the long exposure image and the short exposure image. A ghosting region 830 on an opposing side of the foreground object also exists that is created based on the edges of the misaligned foreground object. For example, an edge between a face region and the background of the image is depicted in the ghosting region 830. In one illustrative aspect, ghosting regions 810 and 830 exist because content from the long exposure image or short exposure image is missing, and a noisy region exists because the long exposure image is missing and the image content must be selected from the short exposure image, which has more noise due to the shorter exposure.

In some aspects, the alignment detrimentally affects the ability of an image capturing system to capture high-quality HDR images using a forward-facing camera. Image capturing system manufacturers either disable the capture of HDR images using a forward-facing camera or limit exposure ratios to reduce noise generated associated with HDR images. As a result, conventional self-portraits captured by an image capturing system limit the dynamic range and constrains the quality of the resulting HDR image.

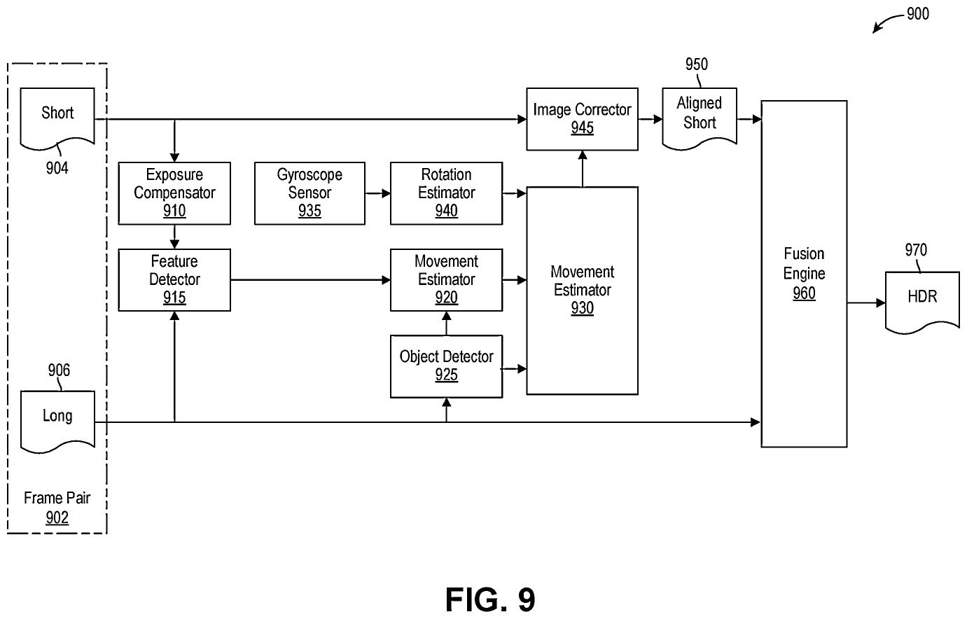

FIG. 9 is a diagram illustrating an example image processing system 900 for synthesizing an HDR image using a hybrid transformation in accordance with some aspects of the disclosure. The frame pair 902 may be provided to the image processing system 900 for processing. An exposure time used for the long exposure image 906 has an exposure time that is longer than an exposure time used for the short exposure image 904.

In one illustrative aspect, the short exposure image 904 is provided to an exposure compensator 910, which increases the brightness of the short exposure image 904 based on an exposure ratio associated with the short exposure image 904 and the long exposure image 906. For example, if the short exposure image 904 has an exposure time of 5 milliseconds (ms) and the long exposure image 906 has an exposure time of 20 ms, the exposure ratio is four and the long exposure image 906 should have four times the brightness as the short exposure image 904. The exposure compensator 910 normalizes the brightness of the short exposure image 904 to correspond to the brightness of the long exposure image 906. The modified short exposure image 904 and the long exposure image 906 are provided to a feature detector 915 to identify key points within each of the images. The feature detector 915 identifies different key points from each of the images and provides the key points to a movement estimator 920. For example, the feature detector 915 is configured to provide a first set of key points to the movement estimator 920 associated with the short exposure image 904 and a second set of key points to the movement estimator 920 associated with the long exposure image 906.

In one aspect, the long exposure image 906 is also provided to an object detector 925 to identify objects of interest in the foreground. In one illustrative example, the object detector 925 is configured to identify a face or multiple faces (e.g., a self-portrait), and is configured to output a bounding region (e.g., a bounding region, or other similar geometric regions that identifies a foreground region in the long exposure image 906) to the movement estimator 920.

In some aspects, movement estimator 920 uses the bounding region and discards key points that are outside of the bounding region. For example, the bounding region corresponds to the foreground region, and discarding key points outside of the foreground regions removes key points associated with the background region from the short exposure image 904 and the long exposure image 906. The movement estimator 920 analyzes the key points associated with the foreground of the short exposure image 904 and the key points associated with the foreground of the long exposure image 906 and determines a translational matrix based on the key points, and the homography matrix can be used to correct the displacement (e.g., movement) of the image capturing system during the image capture. In one illustrative aspect, the translational matrix may be a homography matrix that is determined based on the short exposure image 904 and the long exposure image 906. According to some examples, multiple images of the same planar surface (e.g., multiple images captured as part of an HDR image) are related by a homography matrix that can be used for various corrections in either of the images, such as scaling correction, translational correction, and rotation correction. In some aspects, the movement transformation can be computed based on the differences in the key points associated with the foreground region of the short exposure image 904 and the long exposure image 906.

The movement transformation corresponds to an amount of movement of the image capturing system between the capturing of the short exposure image 904 and the long exposure image 906. In one illustrative example, the movement estimator 920 generates a translational matrix that represents a function associated with at least one pixel in an image or a group of pixels in the image, and the translational matrix can be used to correct a portion of the short exposure image 904 or the long exposure image 906, such as the foreground region detected by the object detector 925. Alternatively or additionally, the translational matrix can be configured to represent an entire image.

The image processing system 900 includes a gyroscope sensor 935 that provides relative or absolute rotational information (e.g., yaw, pitch, and roll) related to the orientation of the image capturing system. For example, the gyroscope sensor 935 can be configured to detect rotation information at the time the short exposure image 904 is captured (e.g., read out) from an image sensor and at the time the long exposure image 906 is captured. The rotation information is provided to a rotation estimator 940 that determines an amount that the image capturing system the rotation estimator 940 is rotated between capturing the short exposure image 904 and the long exposure image 906.

According to one illustrative example, the rotation estimator 940 is configured to generate a rotation matrix (e.g., a homography matrix) based on the rotation information from the gyroscope sensor 935, and the rotation matrix is configured to correct rotation associated with the image capturing system. For example, the rotation matrix can be configured to detect rotation along any axis (e.g., yaw, pitch, roll). The rotation matrix can be applied to one of the short exposure image 904 or the long exposure image 906 to align the content within the short exposure image 904 and the long exposure image 906.

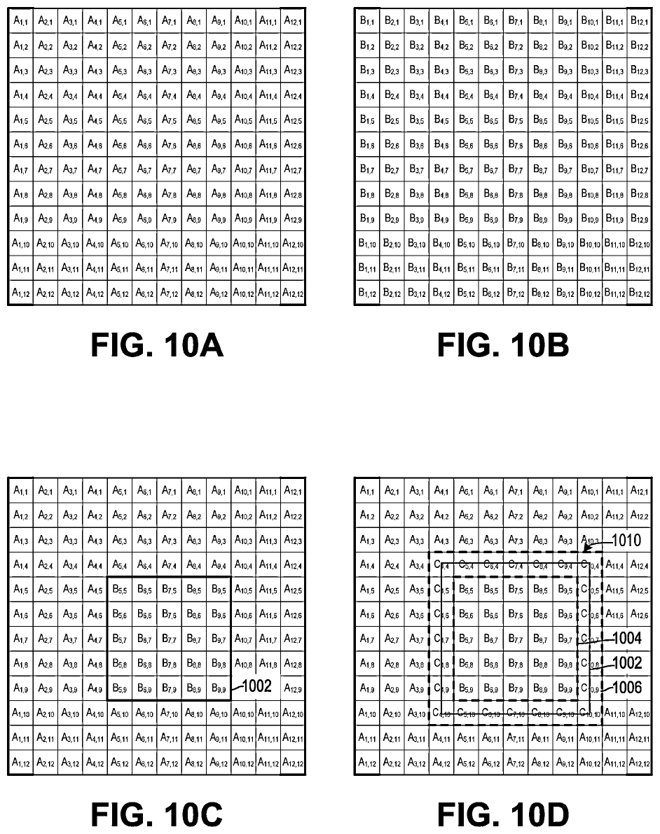

In some aspects, the translational matrix from the movement estimator 920, the rotation matrix from the rotation estimator 940, and the bounding region from the object detector 925 are provided by a movement estimator 930. In some aspects, the movement estimator 930 is configured to identify a transformation based on the translational matrix, the rotation matrix, and the bounding region to apply to the short exposure image 904. Alternatively or additionally, the transformation may be applied to the long exposure image 906. In one illustrative aspect, the movement estimator 930 is configured to synthesize a hybrid transformation matrix, which includes correction information associated with the translational matrix (e.g., translational correction) and correction information associated with the second (e.g., rotational correction). For example, the movement estimator 930 can use the bounding region from the object detector 925 to determine a region of the short exposure image 904 that will be corrected based on translational correction (e.g., based on the movement of key points in the bounding region between the short exposure image 904 and the long exposure image 906), and the remaining region can be associated with the rotational correction, and an example of this matrix is further depicted below with reference to FIG. 10C.

In another aspect, the movement estimator 930 can construct a hybrid transformation that has a first region corresponding to the foreground object based on the translational matrix, a second region corresponding to a background region based on the rotation matrix, and a third border region around the bounding region that interpolates values from the translational matrix and the rotation matrix, and an example of this matrix is further depicted below with reference to FIG. 10D. One example of a border region may include an outer edge region that extends beyond the bounding region and an inner edge region that is within the bounding region. Other examples include the bounding region corresponding to an inner edge of the border region, or the bounding region corresponding to the outer edge of the border region. The size of the border region can be determined based on various factors, such as the size of the bounding region. In another example, the size of the border can be based on a depth map that identifies various regions at different depths and can dynamically size the border region based on the particular details associated with objects in the short exposure image 904 and the long exposure image 906.

The movement estimator 930 may be configured to determine whether the rotation estimation is necessary. For example, if the bounding region corresponds to a threshold of the size of the entire image (e.g., 90%), the movement estimator 930 may determine that correction of background objects is not required.

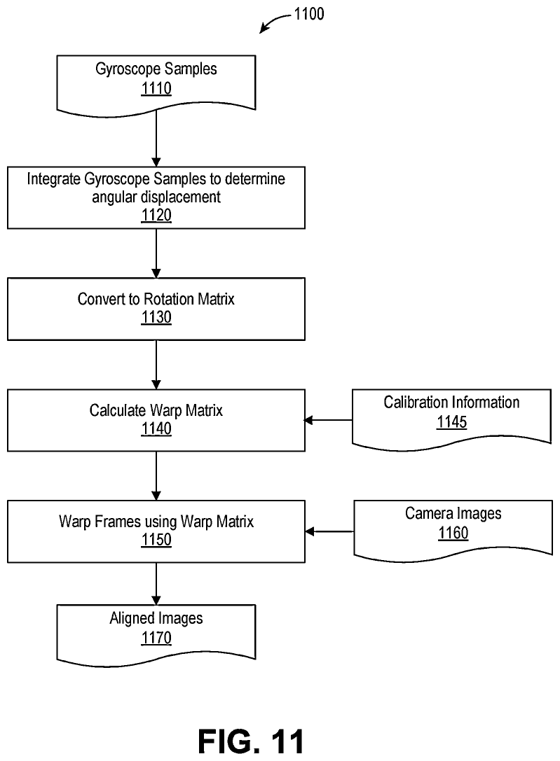

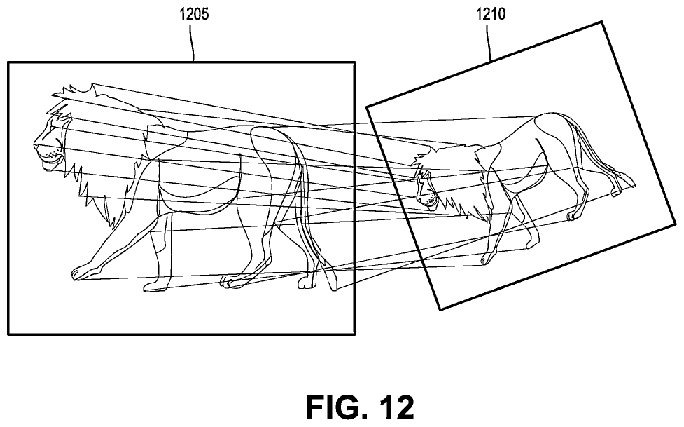

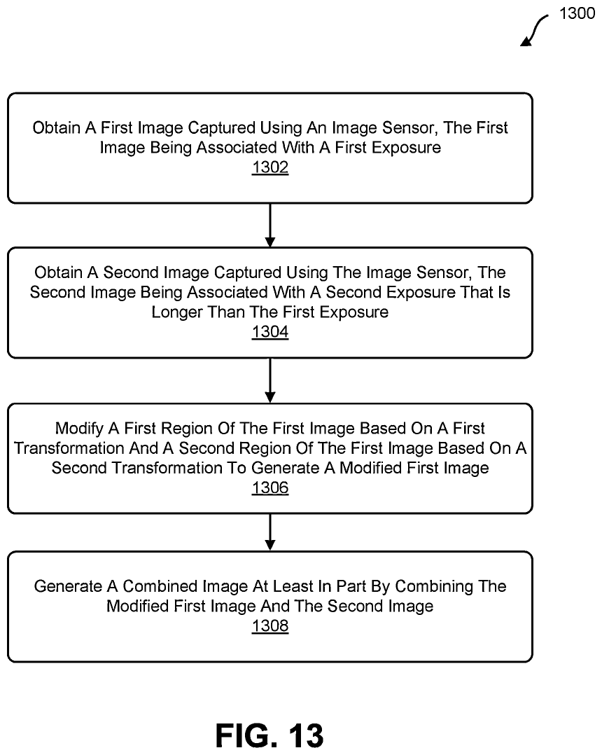

According to one example, the movement estimator 930 may generate a translational matrix that is provided to an image corrector 945. In one illustrative aspect, the image corrector 945 receives the short exposure image 904 and the transformation matrix from the movement estimator 930 and transforms the short exposure image 904 into an aligned short exposure image 950. As described above, the transformation matrix may be configured to transform a portion of the image based on rotational information from the gyroscope sensor 935, movement information determined based on key points detection within the movement estimator 920. Alternatively or additionally, the image corrector 945 may be configured to correct a long exposure image or a supplemental image such as a medium exposure image. The fusion engine 960 is configured to receive the aligned short exposure image 950 and the long exposure image 906 and generate an HDR image 970. As described above, the fusion engine 960 may also receive additional images for various purposes, such as a medium exposure image for reducing noise within the HDR image 970. The additional medium exposure image can also be used to supplement the various movement estimates described above. A flowchart to identify the selective contour filling according to some aspects is illustrated herein with reference to FIG. 13, examples illustrations to explain the various matrixes are illustrated in FIGS. 10A-10D, an example method of correcting rotation is illustrated in FIG. 11, and an example of key point detection is illustrated in FIG. 12.

FIGS. 10A-10D are conceptual diagrams illustrating various matrixes generated by an HDR fusion system to correct spatial and rotational alignment in accordance with some aspects of the disclosure. Although each matrix is depicted with a fill, the fill represents a different type of transformation. For example, FIG. 10A illustrates a rotational matrix that is configured to apply at least one rotational transformation to an image. The amount of rotation of a portion of an image varies based on a number of parameters. Non-limiting examples of a parameter of the rotation include a center point of the rotational movement, a depth of the object in an image, a rotation amount, and a radius of the object with respect to the center point of the rotational movement. As an example, a background object that is 400 meters (m) away from the image capturing system will rotate a larger amount than an object that is Im away from the image capturing system based on the different radii.

FIG. 10B illustrates a translational matrix that is configured to apply at least one spatial transformation to an image. As described above with respect to the movement estimator 920, the translational matrix represents a movement in a coordinate system. For example, the translational matrix can represent movement in cartesian coordinates. In another illustrative example, movement transformation can be represented by an equation that identifies linear transformation or non-linear translation within at least one direction.

FIG. 10C illustrates a combined matrix that is configured to apply a combination of the rotational matrix illustrated in FIG. 10A with the translational matrix illustrated in FIG. 10B. The translational matrix is configured to be applied to a region corresponding to the bounding region 1002 (e.g., the bounding region created by the object detector 925). Table 1 below illustrates a pseudocode that selects a value from the translational matrix and a rotation matrix based on the bounding region 1002.

TABLE 1

```
var combinedMatrix = new Matrix( )
{
Dimensions = long906.Dimensions
};
//Copy pixel associated with maximum brightness into a new image
foreach(Cell cell in combinedMatrix.Cells)
{
if (IsCellwithin(boundingBox, (cell.Location)) {
  cell.Value = movementMatrix.CellAt(cell.Location).Value;
} else {
  cell.Value = rotationMatrix.CellAt(cell.Location).Value;
}
}
```

In the illustrative example in Table 1, a matrix is generated based on the dimensions of the long exposure image 906 so that each pixel in the long exposure image 906 corresponds to a cell within the combined matrix. The matrix in Table 1 can also be generated based on the rotation matrix or the translational matrix. The combined matrix also can have different dimensions (e.g., larger or smaller). The value of each cell is determined based on whether that cell is determined to be within the bounding region 1002 (e.g., from the object detector 925). If the cell is within the bounding region 1002, the cell value is set to be equal to the corresponding cell within the translational matrix. If the cell is not within the bounding region 1002, the value is set to be equal to the corresponding cell within the rotation matrix.

FIG. 10D illustrates a combined matrix that is configured to apply a combination of the rotational matrix illustrated in FIG. 10A with the translational matrix illustrated in FIG. 10B with interpolation within a border region 1010 associated with the bounding region 1002. For example, values of cells within an inner edge 1004 of the bounding region 1002 can be set to values of the corresponding cell within the translational matrix illustrated in FIG. 10B and values of cells that are outside of an outer edge 1006 of the bounding region 1002 can be set to values of the corresponding cell within the rotation matrix illustrated in FIG. 10A. Cells between the inner edge 1004 and the outer edge 1006 are interpolated based on the location of the cell and the corresponding cells in the displacement matrix and the rotation matrix.

For example, a combined matrix, H, can be described as:

$$H = \{ \begin{matrix}{H}_{R} , p > boundary + \frac{margin}{2} \\ {H}_{M} , p < boundary - \frac{margin}{2} \\ {H}_{I} , boundary - \frac{margin}{2} < p < boundary + \frac{margin}{2}\end{matrix} \qquad ( Equation 1 )$$

where p corresponds to a point in the image, margin corresponds to the size of the border, boundary corresponds to the bounding region 1002, HR corresponds to the rotation matrix, HM corresponds to the translational matrix, and Hi is the interpolation of the rotation matrix and the translational matrix as identified in Equation 2 below:

$$( Equation 2 )$$

$${H}_{C} = \frac{\vert ( boundary + \frac{margin}{2} ) - p \vert}{margin} * {H}_{M} + \frac{\vert p - ( boundary - \frac{margin}{2} ) \vert}{margin} * {H}_{R}$$

According to various examples, the size of the border region 1010 may be configured based on a scaled value that is related to the area of the boundary region. For example, the area of the border region 1010 be configured to be 10% of the bounding region 1002, and a portion of the border region 1010 can overlap the bounding region 1002 as illustrated in FIG. 10D. The border region 1010 creates a seamless transition between the foreground and the background region and reduces visual artifacts between the different types of corrections. Based on the combined correction, an imaging system of the instant disclosure reduces aberrational movement associated with different types of motion of the image capturing system and generates a high-quality HDR image. For example, a forward-facing camera of an image capturing system that includes an image processing system 900 can generate an HDR image that reduces visual artifacts such as ghosting and noise and enables capturing of HDR images.

FIG. 11 is a flowchart illustrating an example of a method 1100 for aligning an image to reduce ghosting and noise in an HDR image, in accordance with certain of the present disclosure. The method 1100 can be performed by a computing device having an image sensor, such as a mobile wireless communication device, a camera, an XR device, a wireless-enabled vehicle, or other computing devices. In one illustrative example, a computing system 1600 can be configured to perform all or part of the method 1100. In one illustrative example, an ISP such as the ISP 254 or a computing system 1600 can be configured to perform all or part of the method.

The method 1100 comprises a computing system that can receive gyroscope samples 1110 having rotational information using a gyroscope sensor. In one illustrative example, the gyroscope samples 1110 can include angular velocities (e.g., in radians per second) with respect to cartesian coordinates (e.g., an X, Y, and Z-axis). At block 1120, the computing system can integrate rotational information to determine angular displacement (e.g., a Euler angle) with respect to the cartesian coordinates. In one aspect, Equation 3 below illustrates integrating the angular rotation to determine Euler angles.

$$[ \begin{matrix}{θ}_{X} \\ {θ}_{Y} \\ {θ}_{Z}\end{matrix} ] = {\int }_{previousFrame}^{currentFrame} [ \begin{matrix}{gyro}_{X} \\ gyr {o}_{Y} \\ gyr {o}_{Z}\end{matrix} ] dt = [ \begin{matrix}{R}_{X} \\ {R}_{Y} \\ {R}_{Z}\end{matrix} ] \qquad ( Equation 3 )$$

At block 1130, the computing system can compute the rotation matrix. In one illustrative aspect, the computing system can compute the rotation using Euler transform equation, as illustrated in Equation 4 below.

$$R = {R}_{X} {R}_{Y} {R}_{Z} \qquad ( Equation 4 )$$

Other types of rotational transformation can be used. At block 1140, the computing system calculates the warp matrix W based on receiving calibration information 1145. In some aspects, the calibration information can include intrinsic information associated with the various components of the camera system. The computing system may use the warp matrix at block 1150 to correct rotation motion associated with camera images 1160 to produce aligned images 1170. In one aspect, the warping matrix is determined between the current frame with respect to a previous frame.

In some aspects, the method 1100 can at least partially be implemented in a machine learning (ML) model. In one illustrative example, the ML model to identify rotation can build a depth map to rotate portions of the image based on a distance perceived by the ML model. In another example, the ML model can generate a rotation matrix based on at least two sequential images.

FIG. 12 is a conceptual diagram of key point detection to identify movement of an image capturing system in accordance with certain of the present disclosure. In one aspect, the key detection can be used to detect various features in both the long exposure image and the short exposure image. Examples of feature detectors include Harris corner detection, fast corner detection, histogram of oriented gradient, scale-invariant feature transform, etc. Because the short exposure image is brightened based on the exposure ratio as noted above, the feature detection algorithms should detect the same features between the images. Based on the detected features, a feature matching algorithm (e.g., normalized cross-correlation, Kullback-Leibler divergence (KLD) distance, block matching, etc.) is used to match the corresponding feature points in both the short exposure and the long exposure image. A homography matrix computation between the frames removes outlier key points between the frames and provides an accurate transformation estimation.

In one aspect, FIG. 12 depicts key points that are detected in an original image 1205 that are mapped to a transformed image 1210. In particular, the transformed image is rotated and scaled, and points between various features in the images, such as the rear left foot of the lion and the tail of the lion are mapped between the images. Using the mapping, a homography matrix can be generated that corrects the displacement of the image capturing system between the frames.

In some aspects, the homography matrix can at least be partially determined using an ML model. In one illustrative aspect, at least one of the key point detection algorithm and the feature matching algorithm can be implemented in an ML model. In one illustrative example, the ML model can identify a bounding region that corresponds to a person's shape (e.g., a silhouette mask of the person) in the different images.

FIG. 13 is a flowchart illustrating an example of a method 1300 for synthesizing an HDR image using a background fill technique to reduce ghosting, in accordance with certain of the present disclosure. The method 1300 can be performed by a computing system or device (or component thereof, such as a chipset) having an image sensor, such as a mobile wireless communication device, a camera, an XR device, a wireless-enabled vehicle, or other computing device. In one illustrative example, a computing system 1600 can be configured to perform all or part of the method 1300. In one illustrative example, an ISP such as the ISP 254 can be configured to perform all or part of the method.

At block 1302, the computing system (or component thereof) may be configured to obtain a first image captured using an image sensor, with the first image being associated with a first exposure. At block 1304, the computing system (or component thereof) may be configured to obtain a second image captured using the image sensor. The second image is associated with a second exposure that is longer than the first exposure. For example, the first image may be a short exposure image and the second image may be a long exposure image. According to one illustrative example, the image sensor is oriented in a same direction as a display for displaying preview images captured by the image sensor. For example, the image sensor may be configured to capture self-portrait images of a user of the system.

The computing system (or component thereof) may be configured to generate a first matrix for performing a first transformation and generate a second matrix for performing a second transformation. In one illustrative example, the first transformation comprises a translational matrix associated with movement of the image sensor during the obtaining of the first image and the obtaining of the second image.

For example, the translational matrix may be a homography matrix that corrects movement of the image capturing device that occurs during image capture. In one example, the computing system may normalize the images increasing a brightness of the first image based on an exposure ratio difference between the first image and the second image. The computing system may detect an object such as a face of a person in the second image and determine a bounding region associated with a location of the object in the second image. The computing system may be configured extract first feature points from the first image and may extract second feature points from the second image. Based on the detected feature points and the bounding region, the computing system may identify a subset of the first feature points within the bounding region, identify a subset of the second feature points within the bounding region, and generate the first matrix based on the subset of the first feature points and the subset of the second feature points.

In some aspects, the second matrix may be generated based on movement detected by a motion sensor between a first time when the first image is captured and a second time when the second image is captured. For example, the motion sensor be a gyroscope sensor and detects rotation between the first image and the second image. In this case, the second transformation may be a homography matrix that can correct for a rotational transformation.

According to some aspects, the computing system can generate, based on the first matrix and the second matrix, a hybrid transformation matrix for modifying the first region of the first image and the second region of the first image. For example, the computing system may initiate a new matrix that is referred to as the hybrid transformation matrix, add values from the first matrix to the hybrid transformation matrix that at least correspond to the first region, and add values from the second matrix to the hybrid transformation matrix that at least correspond to the second region.

In one illustrative example, the hybrid transformation matrix may have two distinct regions, with the first region corresponding to the background region and the second region corresponding to the foreground. In another illustrative example, the hybrid transformation matrix may include a third region that exists between the first region and the second region and blends the first transformation matrix and the second transformation matrix. For example, the computing system may determine a transition region between the first region and the second region based on a size of a bounding region associated with a location of an object in at least one of the first image or the second image, determine values associated with the transition region based on a representation of the first matrix and the second matrix, and add the values associated with the transition region to the hybrid transformation matrix. For example, the representation of the first matrix and the second matrix includes a weighted average of the first matrix and the second matrix. In another example, the representation of the first matrix and the second matrix is based on a proportional distance from an inner edge of the transition region to an outer edge of the transition region.

At block 1306, the computing system (or component thereof) may be configured to modify a first region of the first image based on a first transformation and a second region of the first image based on a second transformation to generate a modified first image. In one example, the first region is associated with an object at a first depth in a scene relative to the image sensor, and the second region includes a background region at a second depth in the scene relative to the image sensor. For example, the first region can be associated with a face of a user, or a subject of the image, and the second region can be a background.

At block 1308, the computing system (or component thereof) may generate a combined image at least in part by combining the modified first image and the second image. In one example, the combined image is an HDR image. According to some aspects, the final HDR image is corrected for motion in multiple domains (e.g., rotation, translation). As a result, the final HDR image corrects for the multiple domain motion and can capture an HDR image with high visual fidelity.

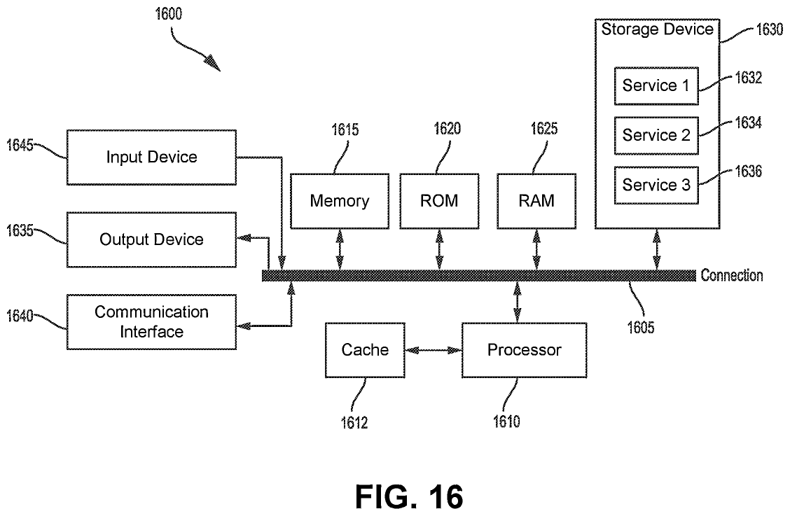

As noted above, the processes or methods described herein (e.g., methods 1100 and 1300, and/or other process described herein) may be performed by a computing system (or device or apparatus). In one example, the methods 1100 and 1300 can be performed by a computing device (e.g., image capture and processing system 200 in FIG. 2) having a computing architecture of the computing system 1600 shown in FIG. 16. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the methods described herein, including the methods 1100 and 1300. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of methods described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The methods 1100 and 1300 are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The methods 1100 and 1300, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

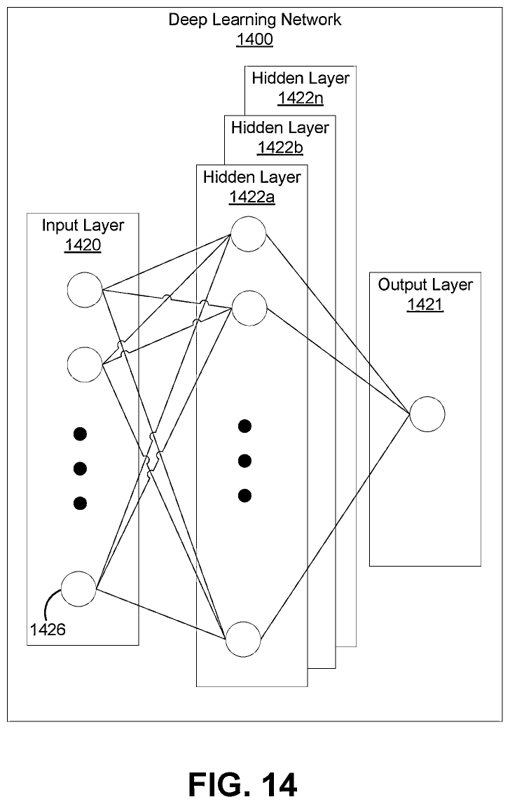

As noted above, various aspects of the present disclosure can use machine learning models or systems. FIG. 14 is an illustrative example of a deep learning neural network 1400 that can be used to implement the machine learning based alignment prediction described above. An input layer 1420 includes input data. In one illustrative example, the input layer 1420 can include data representing the pixels of an input video frame. The neural network 1400 includes multiple hidden layers 1422a, 1422b, through 1422n. The hidden layers 1422a, 1422b, through 1422n include “n” number of hidden layers, where “n” is an integer greater than or equal to one. The number of hidden layers can be made to include as many layers as needed for the given application. The neural network 1400 further includes an output layer 1421 that provides an output resulting from the processing performed by the hidden layers 1422a, 1422b, through 1422n. In one illustrative example, the output layer 1421 can provide a classification for an object in an input video frame. The classification can include a class identifying the type of activity (e.g., looking up, looking down, closing eyes, yawning, etc.).

The neural network 1400 is a multi-layer neural network of interconnected nodes. Each node can represent a piece of information. Information associated with the nodes is shared among the different layers and each layer retains information as information is processed. In some cases, the neural network 1400 can include a feed-forward network, in which case there are no feedback connections where outputs of the network are fed back into itself. In some cases, the neural network 1400 can include a recurrent neural network, which can have loops that allow information to be carried across nodes while reading in input.

Information can be exchanged between nodes through node-to-node interconnections between the various layers. Nodes of the input layer 1420 can activate a set of nodes in the first hidden layer 1422a. For example, as shown, each of the input nodes of the input layer 1420 is connected to each of the nodes of the first hidden layer 1422a. The nodes of the first hidden layer 1422a can transform the information of each input node by applying activation functions to the input node information. The information derived from the transformation can then be passed to and can activate the nodes of the next hidden layer 1422b, which can perform their own designated functions. Example functions include convolutional, up-sampling, data transformation, and/or any other suitable functions. The output of the hidden layer 1422b can then activate nodes of the next hidden layer, and so on. The output of the last hidden layer 1422n can activate one or more nodes of the output layer 1421, at which an output is provided. In some cases, while nodes (e.g., node 1426) in the neural network 1400 are shown as having multiple output lines, a node has a single output and all lines shown as being output from a node represent the same output value.

In some cases, each node or interconnection between nodes can have a weight that is a set of parameters derived from the training of the neural network 1400. Once the neural network 1400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1400 to be adaptive to inputs and able to learn as more and more data is processed.

The neural network 1400 is pre-trained to process the features from the data in the input layer 1420 using the different hidden layers 1422a, 1422b, through 1422n in order to provide the output through the output layer 1421. In an example in which the neural network 1400 is used to identify features and/or objects in images, the neural network 1400 can be trained using training data that includes both images and labels, as described above. For instance, training images can be input into the network, with each training frame having a label indicating the features in the images (for a feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 1400 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1400 is trained well enough so that the weights of the layers are accurately tuned.

For the example of identifying features and/or objects in images, the forward pass can include passing a training image through the neural network 1400. The weights are initially randomized before the neural network 1400 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1400, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1400 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1400 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 1400 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1400 can include any other deep network other than a CNN, such as an autoencoder, a deep belief nets (DBNs), a Recurrent Neural Networks (RNNs), among others.

FIG. 15 is an illustrative example of a CNN 1500. The input layer 1520 of the CNN 1500 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1522a, an optional non-linear activation layer, a pooling hidden layer 1522b, and fully connected hidden layers 1522c to get an output at the output layer 1524. While only one of each hidden layer is shown in FIG. 15, one of ordinary skill will appreciate that multiple convolutional hidden layers, non-linear layers, pooling hidden layers, and/or fully connected layers can be included in the CNN 1500. As previously described, the output can indicate a single class of an object or can include a probability of classes that best describe the object in the image.

The first layer of the CNN 1500 is the convolutional hidden layer 1522a. The convolutional hidden layer 1522a analyzes the image data of the input layer 1520. Each node of the convolutional hidden layer 1522a is connected to a region of nodes (pixels) of the input image called a receptive field. The convolutional hidden layer 1522a can be considered as one or more filters (each filter corresponding to a different activation or feature map), with each convolutional iteration of a filter being a node or neuron of the convolutional hidden layer 1522a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1522a. Each connection between a node and a receptive field for that node learns a weight and, in some cases, an overall bias such that each node learns to analyze its particular local receptive field in the input image. Each node of the hidden layer 1522a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1522a is due to each node of the convolutional layer being applied to its corresponding receptive field. For example, a filter of the convolutional hidden layer 1522a can begin in the top-left corner of the input image array and can convolve around the input image. As noted above, each convolutional iteration of the filter can be considered a node or neuron of the convolutional hidden layer 1522a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1522a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1522a.

The mapping from the input layer to the convolutional hidden layer 1522a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1522a can include several activation maps in order to identify multiple features in an image. The example shown in FIG. 15 includes three activation maps. Using three activation maps, the convolutional hidden layer 1522a can detect three different kinds of features, with each feature being detectable across the entire image.

In some examples, a non-linear hidden layer can be applied after the convolutional hidden layer 1522a. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1500 without affecting the receptive fields of the convolutional hidden layer 1522a.

The pooling hidden layer 1522b can be applied after the convolutional hidden layer 1522a (and after the non-linear hidden layer when used). The pooling hidden layer 1522b is used to simplify the information in the output from the convolutional hidden layer 1522a. For example, the pooling hidden layer 1522b can take each activation map output from the convolutional hidden layer 1522a and generates a condensed activation map (or feature map) using a pooling function. Max-pooling is one example of a function performed by a pooling hidden layer. Other forms of pooling functions be used by the pooling hidden layer 1522a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1522a. In the example shown in FIG. 15, three pooling filters are used for the three activation maps in the convolutional hidden layer 1522a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1522a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1522a having a dimension of 24×24 nodes, the output from the pooling hidden layer 1522b will be an array of 18×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1500.

The final layer of connections in the network is a fully-connected layer that connects every node from the pooling hidden layer 1522b to every one of the output nodes in the output layer 1524. Using the example above, the input layer includes 28×28 nodes encoding the pixel intensities of the input image, the convolutional hidden layer 1522a includes 3×24×24 hidden feature nodes based on application of a 5×5 local receptive field (for the filters) to three activation maps, and the pooling hidden layer 1522b includes a layer of 3×12×12 hidden feature nodes based on application of max-pooling filter to 2×2 regions across each of the three feature maps. Extending this example, the output layer 1524 can include ten output nodes. In such an example, every node of the 3×12×12 pooling hidden layer 1522b is connected to every node of the output layer 1524.

The fully connected layer 1522c can obtain the output of the previous pooling hidden layer 1522b (which should represent the activation maps of high-level features) and determines the features that most correlate to a particular class. For example, the fully connected layer 1522c layer can determine the high-level features that most strongly correlate to a particular class, and can include weights (nodes) for the high-level features. A product can be computed between the weights of the fully connected layer 1522c and the pooling hidden layer 1522b to obtain probabilities for the different classes. For example, if the CNN 1500 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1524 can include an M-dimensional vector (in the prior example, M=10). M indicates the number of classes that the CNN 1500 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 16 is a diagram illustrating an example of a system for implementing certain aspects of the present technology. In particular, FIG. 16 illustrates an example of computing system 1600, which can be for example any computing device making up internal computing system, a remote computing system, a camera, or any component thereof in which the components of the system are in communication with each other using connection 1605. Connection 1605 can be a physical connection using a bus, or a direct connection into processor 1610, such as in a chipset architecture. Connection 1605 can also be a virtual connection, networked connection, or logical connection.

In some aspects, computing system 1600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1600 includes at least one processing unit (CPU or processor) 1610 and connection 1605 that couples various system components including system memory 1615, such as ROM 1620 and RAM 1625 to processor 1610. Computing system 1600 can include a cache 1612 of high-speed memory connected directly with, in close proximity to, or integrated as part of processor 1610.

Processor 1610 can include any general purpose processor and a hardware service or software service, such as services 1632, 1634, and 1636 stored in storage device 1630, configured to control processor 1610 as well as a special-purpose processor where software instructions are incorporated into the actual processor design. Processor 1610 may essentially be a completely self-contained computing system, containing multiple cores or processors, a bus, memory controller, cache, etc. A multi-core processor may be symmetric or asymmetric.

To enable user interaction, computing system 1600 includes an input device 1645, which can represent any number of input mechanisms, such as a microphone for speech, a touch-sensitive screen for gesture or graphical input, keyboard, mouse, motion input, speech, etc. Computing system 1600 can also include output device 1635, which can be one or more of a number of output mechanisms. In some instances, multimodal systems can enable a user to provide multiple types of input/output to communicate with computing system 1600. Computing system 1600 can include communications interface 1640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1640 may also include one or more Global Navigation Satellite System (GNSS) receivers or transceivers that are used to determine a location of the computing system 1600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1630 can include software services, servers, services, etc., that when the code that defines such software is executed by the processor 1610, it causes the system to perform a function. In some aspects, a hardware service that performs a particular function can include the software component stored in a computer-readable medium in connection with the necessary hardware components, such as processor 1610, connection 1605, output device 1635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative examples of the disclosure include:

Aspect 1. A method of processing one or more images, comprising: obtaining a first image captured using an image sensor, the first image being associated with a first exposure; obtaining a second image captured using the image sensor, the second image being associated with a second exposure that is longer than the first exposure; modifying a first region of the first image based on a first transformation and a second region of the first image based on a second transformation to generate a modified first image; and generating a combined image at least in part by combining the modified first image and the second image.

Aspect 2. The method of Aspect 1, wherein the image sensor is oriented in a same direction as a display for displaying preview images captured by the image sensor.

Aspect 3. The method of any of Aspects 1 to 2, wherein the first region is associated with an object at a first depth in a scene relative to the image sensor, and wherein the second region includes a background region at a second depth in the scene relative to the image sensor.

Aspect 4. The method of any of Aspects 1 to 3, further comprising: generating a first matrix for performing the first transformation; and generating a second matrix for performing the second transformation.

Aspect 5. The method of any of Aspects 1 to 4, wherein the second matrix is generated based on movement detected by a motion sensor between a first time when the first image is captured and a second time when the second image is captured.

Aspect 6. The method of any of Aspects 1 to 5, wherein the motion sensor comprises a gyroscope sensor, and wherein the second transformation comprises a rotational transformation.

Aspect 7. The method of any of Aspects 1 to 6, wherein generating the first matrix comprises: extracting first feature points from the first image; and extracting second feature points from the second image.

Aspect 8. The method of any of Aspects 1 to 7, further comprising: increasing a brightness of the first image based on an exposure ratio difference between the first image and the second image.

Aspect 9. The method of any of Aspects 1 to 8, further comprising: detecting an object in the second image; and determining a bounding region associated with a location of the object in the second image.

Aspect 10. The method of any of Aspects 1 to 9, further comprising: identifying a subset of the first feature points within the bounding region; identifying a subset of the second feature points within the bounding region; and generating the first matrix based on the subset of the first feature points and the subset of the second feature points.

Aspect 11. The method of any of Aspects 1 to 10, generating, based on the first matrix and the second matrix, a hybrid transformation matrix for modifying the first region of the first image and the second region of the first image.

Aspect 12. The method of any of Aspects 1 to 11, wherein generating the hybrid transformation matrix comprises: adding values from the first matrix to the hybrid transformation matrix that at least correspond to the first region; and adding values from the second matrix to the hybrid transformation matrix that at least correspond to the second region.

Aspect 13. The method of any of Aspects 1 to 12, further comprising: determining a transition region between the first region and the second region based on a size of a bounding region associated with a location of an object in at least one of the first image or the second image; determining values associated with the transition region based on a representation of the first matrix and the second matrix; and adding the values associated with the transition region to the hybrid transformation matrix.

Aspect 14. The method of any of Aspects 1 to 13, wherein the representation of the first matrix and the second matrix includes a weighted average of the first matrix and the second matrix.

Aspect 15. The method of any of Aspects 1 to 14, wherein the representation of the first matrix and the second matrix is based on a proportional distance from an inner edge of the transition region to an outer edge of the transition region.

Aspect 16. The method of any of Aspects 1 to 15, wherein the first transformation comprises a translational matrix associated with movement of the image sensor during the obtaining of the first image and the obtaining of the second image.

Aspect 17. The method of any of Aspects 1 to 16, wherein the combined image is an HDR image.

Aspect 18. An apparatus for processing one or more images including at least one modem (e.g., implemented in circuitry), a processor (or processors) coupled to the transceiver, and at least one memory communicatively coupled with the at least one processor and storing processor-readable code. The processor-readable code, when executed by the at least one processor in conjunction with the at least one modem, is configured to: obtain a first image captured using an image sensor, the first image being associated with a first exposure; obtain a second image captured using the image sensor, the second image being associated with a second exposure that is longer than the first exposure; modify a first region of the first image based on a first transformation and a second region of the first image based on a second transformation to generate a modified first image; and generate a combined image at least in part by combining the modified first image and the second image.

Aspect 19. The apparatus of Aspect 18, wherein the image sensor is oriented in a same direction as a display for displaying preview images captured by the image sensor.

Aspect 20. The apparatus of any of Aspects 18 to 19, wherein the first region is associated with an object at a first depth in a scene relative to the image sensor, and wherein the second region includes a background region at a second depth in the scene relative to the image sensor.

Aspect 21. The apparatus of any of Aspects 18 to 20, wherein the processor-readable code, when executed by the at least one processor in conjunction with the at least one modem, is configured to: generate a first matrix for performing the first transformation; and generate a second matrix for performing the second transformation.

Aspect 22. The apparatus of any of Aspects 18 to 21, wherein the second matrix is generated based on movement detected by a motion sensor between a first time when the first image is captured and a second time when the second image is captured.

Aspect 23. The apparatus of any of Aspects 18 to 22, wherein the motion sensor comprises a gyroscope sensor, and wherein the second transformation comprises a rotational transformation.

Aspect 24. The apparatus of any of Aspects 18 to 23, wherein the processor-readable code, when executed by the at least one processor in conjunction with the at least one modem, is configured to: extract first feature points from the first image; and extract second feature points from the second image.

Aspect 25. The apparatus of any of Aspects 18 to 24, wherein the processor-readable code, when executed by the at least one processor in conjunction with the at least one modem, is configured to: increase a brightness of the first image based on an exposure ratio difference between the first image and the second image.

Aspect 26. The apparatus of any of Aspects 18 to 25, wherein the processor-readable code, when executed by the at least one processor in conjunction with the at least one modem, is configured to: detect an object in the second image; and determine a bounding region associated with a location of the object in the second image.

Aspect 27. The apparatus of any of Aspects 18 to 26, wherein the processor-readable code, when executed by the at least one processor in conjunction with the at least one modem, is configured to: identify a subset of the first feature points within the bounding region; identify a subset of the second feature points within the bounding region; and generate the first matrix based on the subset of the first feature points and the subset of the second feature points.

Aspect 28. The apparatus of any of Aspects 18 to 27, wherein based on the first matrix and the second matrix, a hybrid transformation matrix for modifying the first region of the first image and the second region of the first image.

Aspect 29. The apparatus of any of Aspects 18 to 28, wherein the processor-readable code, when executed by the at least one processor in conjunction with the at least one modem, is configured to: add values from the first matrix to the hybrid transformation matrix that at least correspond to the first region; and add values from the second matrix to the hybrid transformation matrix that at least correspond to the second region.

Aspect 30. The apparatus of any of Aspects 18 to 29, wherein the processor-readable code, when executed by the at least one processor in conjunction with the at least one modem, is configured to: determine a transition region between the first region and the second region based on a size of a bounding region associated with a location of an object in at least one of the first image or the second image; determine values associated with the transition region based on a representation of the first matrix and the second matrix; and add the values associated with the transition region to the hybrid transformation matrix.

Aspect 31. apparatus of any of Aspects 18 to 30, wherein the representation of the first matrix and the second matrix includes a weighted average of the first matrix and the second matrix.

Aspect 32. The apparatus of any of Aspects 18 to 31, wherein the representation of the first matrix and the second matrix is based on a proportional distance from an inner edge of the transition region to an outer edge of the transition region.

Aspect 33. The apparatus of any of Aspects 18 to 32, wherein the first transformation comprises a translational matrix associated with movement of the image sensor during the obtaining of the first image and the obtaining of the second image.

Aspect 34. The apparatus of any of Aspects 18 to 33, wherein the combined image is an HDR image.

Aspect 35. A non-transitory computer-readable medium comprising instructions which, when executed by one or more processors, cause the one or more processors to perform operations according to any of Aspects 1 to 17.

Aspect 36. An apparatus comprising means for performing operations according to any of Aspects 1 to 17.

What is claimed is:

1. A method of processing one or more images, comprising:
obtaining a first image captured using an image sensor, the first image being associated with a first exposure;
obtaining a second image captured using the image sensor, the second image being associated with a second exposure that is longer than the first exposure;
modifying a first region of the first image based on a first transformation and a second region of the first image based on a second transformation to generate a modified first image; and
generating a combined image at least in part by combining the modified first image and the second image.

2. The method of claim 1, wherein the image sensor is oriented in a same direction as a display for displaying preview images captured by the image sensor.

3. The method of claim 1, wherein the first region is associated with an object at a first depth in a scene relative to the image sensor, and wherein the second region includes a background region at a second depth in the scene relative to the image sensor.

4. The method of claim 1, further comprising:
generating a first matrix for performing the first transformation; and
generating a second matrix for performing the second transformation.

5. The method of claim 4, wherein the second matrix is generated based on movement detected by a motion sensor between a first time when the first image is captured and a second time when the second image is captured.

6. The method of claim 5, wherein the motion sensor comprises a gyroscope sensor, and wherein the second transformation comprises a rotational transformation.

7. The method of claim 4, wherein generating the first matrix comprises:
extracting first feature points from the first image; and
extracting second feature points from the second image.

8. The method of claim 7, further comprising:
increasing a brightness of the first image based on an exposure ratio difference between the first image and the second image.

9. The method of claim 7, further comprising:
detecting an object in the second image; and
determining a bounding region associated with a location of the object in the second image.

10. The method of claim 9, further comprising:
identifying a subset of the first feature points within the bounding region;
identifying a subset of the second feature points within the bounding region; and
generating the first matrix based on the subset of the first feature points and the subset of the second feature points.

11. The method of claim 4, further comprising:
generating, based on the first matrix and the second matrix, a hybrid transformation matrix for modifying the first region of the first image and the second region of the first image.

12. The method of claim 11, wherein generating the hybrid transformation matrix comprises:
adding values from the first matrix to the hybrid transformation matrix that at least correspond to the first region; and
adding values from the second matrix to the hybrid transformation matrix that at least correspond to the second region.

13. The method of claim 12, further comprising:
determining a transition region between the first region and the second region based on a size of a bounding region associated with a location of an object in at least one of the first image or the second image;
determining values associated with the transition region based on a representation of the first matrix and the second matrix; and
adding the values associated with the transition region to the hybrid transformation matrix.

14. The method of claim 13, wherein the representation of the first matrix and the second matrix includes a weighted average of the first matrix and the second matrix.

15. The method of claim 13, wherein the representation of the first matrix and the second matrix is based on a proportional distance from an inner edge of the transition region to an outer edge of the transition region.

16. The method of claim 1, wherein the first transformation comprises a translational matrix associated with movement of the image sensor during the obtaining of the first image and the obtaining of the second image.

17. The method of claim 1, wherein the combined image is a high dynamic range (HDR) image.

18. An apparatus for processing one or more images, the apparatus comprising:
at least one memory; and
at least one processor coupled with the at least one memory, wherein the at least one processor is configured to:
obtain a first image captured using an image sensor, the first image being associated with a first exposure;
obtain a second image captured using the image sensor, the second image being associated with a second exposure that is longer than the first exposure;
modify a first region of the first image based on a first transformation and a second region of the first image based on a second transformation to generate a modified first image; and
generate a combined image at least in part by combining the modified first image and the second image.

19. The apparatus of claim 18, wherein the image sensor is oriented in a same direction as a display for displaying preview images captured by the image sensor.

20. The apparatus of claim 18, wherein the first region is associated with an object at a first depth in a scene relative to the image sensor, and wherein the second region includes a background region at a second depth in the scene relative to the image sensor.

21. The apparatus of claim 18, wherein the at least one processor is configured to:
generate a first matrix for performing the first transformation; and
generate a second matrix for performing the second transformation.

22. The apparatus of claim 21, wherein the at least one processor is configured to generate the second matrix based on movement detected by a motion sensor between a first time when the first image is captured and a second time when the second image is captured.

23. The apparatus of claim 22, wherein the motion sensor comprises a gyroscope sensor, and wherein the second transformation comprises a rotational transformation.

24. The apparatus of claim 21, wherein the at least one processor is configured to:
extract first feature points from the first image; and
extract second feature points from the second image.

25. The apparatus of claim 24, wherein the at least one processor is configured to:
increase a brightness of the first image based on an exposure ratio difference between the first image and the second image.

26. The apparatus of claim 24, wherein the at least one processor is configured to:
detect an object in the second image; and
determine a bounding region associated with a location of the object in the second image.

27. The apparatus of claim 26, wherein the at least one processor is configured to:
identify a subset of the first feature points within the bounding region;
identify a subset of the second feature points within the bounding region; and
generate the first matrix based on the subset of the first feature points and the subset of the second feature points.

28. The apparatus of claim 21, wherein the at least one processor is configured to:
generate, based on the first matrix and the second matrix, a hybrid transformation matrix for modifying the first region of the first image and the second region of the first image.

29. The apparatus of claim 28, wherein the at least one processor is configured to:
add values from the first matrix to the hybrid transformation matrix that at least correspond to the first region; and
add values from the second matrix to the hybrid transformation matrix that at least correspond to the second region.

30. The apparatus of claim 29, wherein the at least one processor is configured to:
determine a transition region between the first region and the second region based on a size of a bounding region associated with a location of an object in at least one of the first image or the second image;
determine values associated with the transition region based on a representation of the first matrix and the second matrix; and
add the values associated with the transition region to the hybrid transformation matrix.
